(19) United States
(12) Patent Application Publication
(10) Pub. No.: US 2024/0331493 A1
(43) Pub. Date: Oct. 3, 2024

(54) Computer Implemented Systems And Methods

(71) Applicant: Felix Römer, Tigne Point (MT)

(72) Inventor: Felix Römer, Tigne Point (MT)

(21) Appl. No.: 18/293,461

(22) PCT Filed: Aug. 2, 2022
(86) PCT No.: PCT/EP2022/071664

§ 371 Date: Jan. 30, 2024

(30) Foreign Application Priority Data
Aug. 2, 2021 (GB) 2111100.0
Aug. 23, 2021 (GB) 2112093.6

(51) Int. Cl. G07F 17/32

(52) U.S. Cl. CPC G07F 17/3227; G07F 17/323; G07F 17/3279

(57) ABSTRACT

The invention resides in a method of operating a host server, including configuring an interface for receiving confirmation that a plurality of users have complied with a condition, e.g. they've agreed upon and committed to playing a game, configuring an emulator to perform a set of actions upon a provider server on behalf of each of the plurality of users, said set of actions defined by at least one user, wherein the emulator determines and compares the outcome of each of the emulated set of actions and communicates the outcome to each of the plurality of users. The invention also resides in a method of operating a provider server configured to communicate with such an emulator to support the secure and efficient implementation of the set of actions.

### FIELD

This disclosure generally relates to methods and systems for coordinating the actions of two or more users and securing interactions and/or outcomes therebetween in an on-line environment. The disclosure is particularly suited, but not limited, to the interactions that occur between system elements, such as a user interface, host server and remote server that perform said actions, as well as those system elements. Examples enable secure and coordinated actions during on-line game interaction in which two or more users compete in a game e.g. on-line casino games, such as slots.

### BACKGROUND

A user performing actions on a remote server is known, particularly during single-player on-line game-play. Multi-player on-line games are more complicated because the system and methods must accommodate limitations in the infrastructure and inhibit cheating. Remote servers can be limited in their responsiveness because of network latency caused by the series of jumps or hops from router to router, the routers themselves and the handling of data packets. Lag between an instruction and an action is not only indicative of an inadequate system but can make the game-play vulnerable to attack.

Some actions require accurate and deterministic outcomes and, therefore, predictive outcomes become unacceptable. In combination with lag, the actions required by users or players can be inconsistent or unsynchronised.

### SUMMARY

Generally, the invention resides in a method of operating a host server, including configuring an interface for receiving confirmation that a plurality of users have complied with a condition, e.g. they've agreed upon a set of actions representing game-play and committed to playing said game, configuring an emulator to perform the set of actions upon a provider server on behalf of each of the plurality of users, said set of actions defined by at least one user, wherein the emulator determines and compares the outcome of each of the emulated set of actions and communicates the outcome to each of the plurality of users. The invention also resides in a provider server configured to communicate with such an emulator to support the secure and efficient implementation of the set of actions. In a conventional single-player game a user opens a browser and connects to an on-line gaming host platform, such as an on-line casino, which communicates with a game provider's server to establish a game session for the user. However, configuring a gaming host platform, a game provider's server or any part of the system that supports multiple players requires alternative connections and operations to provide secure and efficient implementation of actions that enable game-play with at least reduced lag, improved security, synchronized communications and less cheating.

According to an aspect of the invention, there resides a method of operating a host server including configuring an interface for receiving from a plurality of users and operating a provider server. The interface can be an API endpoint for user interaction and/or game configuration. The method comprises providing an interface for communicating with a plurality of user-interfaces. The user interfaces can by any device supporting an application programme interface (API), such as a browser, app on a mobile device, desktop computer app or gaming device. The method also comprises receiving instructions from the user-interfaces that determine a set of actions and to be performed on a provider server and a condition. The set of actions can be predetermined actions within a game, which in the example of a casino slots game can include setting the number of spins of the reels, the speed of the spins and bet size, while the condition can include receiving commitment from a required number of users to perform the actions, and play a game. The invention further comprises determining whether the set of actions and the condition are accepted by the plurality of users, including a first user and a second user; and configuring an emulator in response to the condition being met, said emulator configured to: establish communication with a provider server upon determining that the set of actions and the condition are accepted; emulating the set of actions for each of the plurality of users by initiating automatic execution of the set of actions upon the provider server; and updating the plurality of user-interfaces with an outcome of the actions. The emulator can function to at least one of establish a communication channel with a remote server, manage the communications with said server, determine/control a set of actions performed by the remote server and determine the outcome of said set of actions.

The invention can accommodate two or more users. Each user, via an emulator, can perform a set of actions common to each participating user. The emulator can function like an automated API, and seek endpoints from the provider server. The emulator can communicate with the service provider, which can be a provider server, in series or parallel, wherein each user can be represented by a separate and distinct emulation of the set of actions. The set of actions can be performed separately for each participating user. Said set of actions can be performed in parallel. The emulator can perform a set of actions on behalf of a player.

Overall, the emulator and the corresponding interfaces of the provider server, can be said to provide dedicated and secure channels between the host server and the provider server. The function of the emulator can inhibit cheating by the competing users and the secure channels enable the emulator to synchronise game-play and/or each stage of the game-play to improve security and/or minimise latency during game-play.

The emulation for the plurality of users can occur in parallel. In response to said condition being met the set of actions can be locked and inhibited from reconfiguration by any of the plurality of users. In other words, one or more communication channels with endpoints can be shared by participating users by sending information with user-specific parameters.

Alternatively, emulation for each game can be via a dedicated endpoint for said game. Emulation can be centralised and communications and/or requests from different users e.g. participating in a game, can have different parameters for each user. The emulation for the plurality of users can occur in series.

The host server and/or the provider server can communicate, at least in part, progress on the outcome of the emulation to the interface and/or the users. The provider server can update the host server on progress on a set of actions e.g. game-play via the emulator, while ancillary functions within the host server can provide additional information to the users. The status and/or progress on the set of actions being requested by the emulator and/or performed by the provider server can be communicated and/or streamed to the plurality of users.

The status and/or progress on the set of actions can be communicated and/or streamed to the participants requesting the set of actions via the emulators and, additionally, to at least one non-participating third party who requests the host server to observe. A separate endpoint can be configured in the host server and/or the provider server for access to view the emulator perform a set of actions.

The third party can be a passive user requesting via the interface to observe the progress on the outcome of the emulation to the interface, without participating in the emulation of actions, and the server communicates progress on the outcome of the emulation to the interface.

The emulator 106 can instruct a provider server to perform a set of actions on behalf of a user. The provider server can provide a response to the user and/or the emulator. The host server can collate at least one of a simulation and/or replay of the performance of the set of actions and the outcome of the set of actions and present said collated information at upon a user interface. In this way, a set of actions representing game-play can be recorded and/or replayed by host server 104. The replay of each game can be gathered by the host server and collectively presented to each or all players or observers. The outcome of the set of actions representing game-play is unaffected by the recording and replaying of the game because the delivery of the results are merely postponed to coincide, substantially, with the normal amount of time required to perform a set of actions. This second approach minimises the changes to the operation methods by the provider server to make modifications to accommodate multiple users. Moreover, collation of the game results and simulation and/or replay by the host server 104 can provide secure and efficient communication that inhibits any tampering with game-play. Therefore, synchronisation issues are inhibited and each user can perceive game-play as occurring substantially simultaneously with other game players.

The emulation of the set of actions for each of the first user and the second user and/or progress on the outcome of the emulation to the interface can be repeated. The emulation of the set of actions can include a separate emulator and/or emulation process for each of the first user and the second user. Alternatively, a single emulator can perform that set of actions on behalf of all participating users.

The outcome of the set of actions emulated for the first user can be compared to the outcome of the set of actions emulated for the second user. The outcome of a set of actions can determine a score. The first user and the second user allocate a resource to their respective set of actions, and the outcome of the emulation can modify the respective resource, which determines the respective score, wherein the scores of the first user and the second user are compared. The resource accumulated when all emulations are complete can be allocated to the user with the greatest score.

For the avoidance of doubt, reference herein to the first user and the second user does not limit the invention to two participating players and the invention can be scaled for any number of users e.g. up to 100, or up to 1000 or more.

The plurality of users can operate the interface via a user-interface via which the users can engage with a host server to define the set of actions and/or meet the conditions, wherein upon meeting the condition the host server can establishes a connection with the provider server via an endpoint and/or emulate the set of actions for each of the plurality of users. The emulator can request game-play for each player and/or a viewing window, and the provider server returns a connection e.g. a URL.

Endpoints can be provided for each user's emulation or a single endpoint can be provided for all users participating in a game, wherein the requests sent to the endpoints would have different parameters for each user.

The user interface can by any device supporting an application programme interface (API), such as a browser, app on a mobile device, desktop computer app or gaming device.

The actions to be executed can include electronic game-play actions and/or at least one of an in-game character action, non-player character action and a user-action. The electronic game-play can represent a casino game. The host server can be an on-line casino. The provider server can be a game provider. A casino game can include, but is not limited to, slots, bingo, dice and other such games. The invention enables a battle between competing players or a game.

According to another aspect of the invention, there resides a method of configuring a provider server configured to execute instructions determined by a plurality of users via an emulator, the method comprising: configuring an interface to receive instructions that determine a set of actions, said set of actions (i) determined by a plurality of remote users and/or (ii) determined by requests received from a host server; providing a plurality of endpoints configured to engage with an emulator of a host server, said endpoints configured to receive at least one of an input from the emulator simulating the operation of a user selecting an action, and a request from the emulator to perform an action, wherein said action is part of a set of actions determined from a plurality of different users; and configuring a processor to execute the set of actions received from the emulator and update at least one of the plurality of user-interfaces and the emulator with an outcome of the actions via the plurality of endpoints.

The provider server functions to implement the set of actions and/or fulfil the requests from the host server and/or emulator. The provider server can accommodate operation instructions, such as ‘mouse and click’, although preferably is configured to receive operation-specific requests directly from the emulator, wherein said requests can be coded with user-specific parameters.

According to another aspect of the invention, there resides a method of configuring a system for automatically performing actions on a provider server providing a platform for executing actions, said remote provider said actions determined by a plurality of users, said method comprising: configuring via an interface a set of actions and a condition, and accepting the set of actions and a condition, wherein the set of actions and the condition are determined and accepted by the plurality of users, including a first user and a second user; in response to said condition being met, initiating automatic execution of the set of actions upon the provider server, wherein the execution of the set of actions is emulated; emulating the set of actions for each of the plurality of users.

The provider server can be one of a plurality of provider servers selectably accessed via an aggregator, said aggregator functioning for at least part of the method, as an intermediary gateway between at least one of the user, a host server and a provider server. The provider server can be a game provider, and the set of actions can be game-play.

According to another aspect of the invention, there resides a host server configured to provide an interface to a plurality of users and operate a provider server, the host server comprising: an interface configured to: communicate with a plurality of user-interfaces; receive instructions that determine a set of actions and a condition; and determine whether the set of actions and the condition are accepted by the plurality of users, including a first user and a second user; and an emulator, configured to: establish communication with a provider server upon determining that the set of actions and the condition are accepted; and initiate automatic execution of the set of actions upon the remote server, and update the plurality of user-interfaces with an outcome of the actions.

According to another aspect of the invention, there resides a provider server configured to execute instructions determined by a plurality of users, the provider server comprising: an interface configured to receive instructions that determine a set of actions, said set of actions (i) determined by a plurality of remote users and/or (ii) determined by requests received from a host server; a plurality of endpoints configured to engage with an emulator of a host server, said endpoints configured to receive at least one of an input from the emulator simulating the operation of a user selecting an action, and a request from the emulator to perform an action, wherein said action is part of a set of actions determined from a plurality of different users; and a processor configured to execute the set of actions received from the emulator and update at least one of the plurality of user-interfaces and the emulator with an outcome of the actions via the plurality of endpoints.

According to another aspect of the invention, there resides an aggregator configured to function, at least in part, as an intermediary gateway connected to at least one of the host server and the provider server as described and claimed herein.

According to another aspect of the invention, there resides a non-transitory computer-readable storage medium having stored thereon executable instructions that, as a result of being executed by a processor of a computer system, cause the computer system to perform at least one of the computer-implemented methods claimed herein.

Overall, the invention enables at least two players to compete against one another in a manner that is secure and inhibits cheating. This can be achieved through the host server implementing emulators that perform the set of actions required for game-play on behalf of the competing users. Through the methods and systems herein, fewer resources are required because the emulators can at least one of improve security, synchronise game-play, synchronise each stage of game-play and minimise latency issues that can occur between users, a host server and a provider server, all of which can reside in different remote locations. The invention enables efficient use of resources—in the communications and/or processing of the set of actions that emulate game-play.

### BRIEF DESCRIPTION OF THE DRAWINGS

Aspects and examples of the present disclosure will now be described, by way of example only, and with reference to the accompany drawings, in which:

FIG. 1 is a portion of a user-interface in which a user can check the actions of an existing game, which they can select to join or watch, or create a new game and set of actions

FIG. 2 is a portion of a user-interface in which a user can search for another game, or configure the actions to be performed in a game;

FIG. 3 shows schematic views of portion of respective a user-interface during game-play in which operable buttons are deactivated for the user;

FIG. 4 shows schematic views of portion of respective a user-interface of the outcome of a game;

FIG. 5 shows a portion of a user-interface that includes the history of winning games;

FIG. 6 shows the stages of game-play as implemented by an emulator, which can include a bot for a plurality of players;

FIG. 7 shows schematic views of a portion of respective user-interfaces during game-play in which deactivated buttons are illustrated as being operated by respective bots of an emulator;

FIG. 8 shows schematic views of a portion of respective user-interfaces after game-play is complete;

FIG. 9 is a system diagram of a system for multi-player execution of actions suitable for game-play;

FIG. 10 is a flow chart of the steps taken during multi-player game; and

FIG. 11 is a schematic of an element of the system.

### DETAILED DESCRIPTION OF ILLUSTRATIVE EXAMPLES OF THE DISCLOSURE

Possible examples and use cases are now provided for the purpose of illustration, without limitation. The following description relates to the configuration of coordinated actions that are represented by game-play. In particular the invention relates to the configuration of a set of actions and the setting of a condition to be met before these actions commence and the outcome is subsequently determined.

The term ‘user’ is applied when an operator, such as a human operator, configures a set of actions. The term ‘player’ is used when the set of actions relate to game-play. However, the term ‘user’ and ‘player’ are considered interchangeable.

More specifically, in the example, a first user configures a player-vs-player casino game e.g. a slots game, that is accepted by a second user. A set of actions, represented by game-play, are then emulated on behalf of each player before the outcome of the game is determined by comparing the results of the respective actions, which have been performed on behalf of the first user and the second user respectively. In other words, each user agrees to perform a set of actions e.g. a number of slot spins as per the accepted game configuration, the corresponding actions are performed and the outcome determined by an emulator. The user who obtains the highest score keeps their own ‘winnings’ and the winnings of all other players. The example is not limited to slots games or casino games and can be applied to any multiplayer game in which a user's actions during game-play can be emulated. The example provided below shows two users or players but the invention can be scaled for any number of users e.g. up to 100, or up to 1000 or more.

In a conventional single-player game a user opens a browser and connects to an on-line gaming host platform, such as an on-line casino, which communicates with a game provider's server to establish a game session for the user. However, configuring a gaming host platform, a game provider's server or any part of the system that supports multiple players requires alternative connections and operations to provide secure and efficient implementation of actions that enable game-play with reduced lag and less cheating.

While the invention is suitable for multiple users, the following example in FIGS. 1 through to 10 demonstrate steps involved when two users i.e. first and second players, play each other in a duel, in which they configure a common slots game that they play individually through an emulator. It is also possible for a third participant to watch the game without playing.

The emulator can be referred to as a ‘bot’ and functions to perform at least one of a set of actions, communication operations, determine whether a condition has been met and determine an outcome of the set of actions. These actions simulate game-play on behalf of the players, as per the configuration of the game. During the performing of the set of actions the players can observe their own game-play i.e. set of actions being performed and the game-play of the other players. The game-play is preferably observed in a live-stream. It is important to note that after the set of actions has been initiated and/or game-play has commenced that the players are unable to interrupt or adjust game-play, thus preventing corruption or cheating by a player.

The invention further engages the players, offers the players a greater opportunity to obtain a higher score or winnings, and succeeding over at least one other player in a competition-type environment.

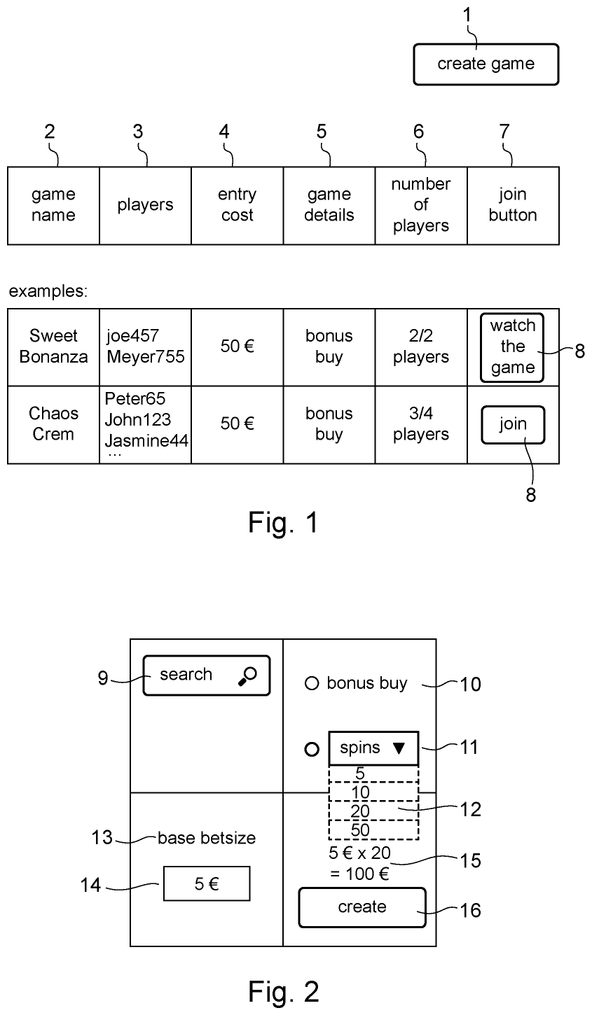

Users engage with the game host and/or other users via an interface, which can include one of a browser, desktop app, mobile app, or any other type of app that enables then to access a screen as shown in FIG. 1. In FIG. 1 a player is presented with a summary of the games that are available to play, and a selectable create game button 1 that enables them to add a game of their own design that, when created, would appear on the same screen as a new row. The summary of games has a table including columns, as follows: slot game name 2, for identifying the games that can be joined or watched; players 3, which lists those players, and their user-names, in the game and/or available places for another player to join, as indicated by the ellipsis for the game ‘Chaos Crem’; the entry cost 4, which indicates the cost of participation, which in this example of indicated as 50€ although could be another amount, such as points, a status level or other wager; game details 5, which indicates the style of the game or the name of the game format such that a player joining knows what game they would be participating in; the number of players, which indicates whether a game has enough players and is ready to play, or playing, or whether there is capacity e.g. ‘¾’—three of four players have joined; and a join button column 7, in which a player can select a button 8 that enables the player to either watch another game without participating or join a game. If the create game button 1 is selected in FIG. 1, the interface of FIG. 2 is presented to the player in which they can create a game for addition to the table of FIG. 1. In the interface for creating a game a player can select a search button 9 for searching for a preferred game, analogous to a set of actions to be followed, or be presented with a selection of games to choose from. In relation to configuring the variables on a slots game, the user can select a bonus buy 10 option and/or select a drop-down menu for spins 11, thus choosing whether the game to be played will involve, for example, 5, 10, 20 or 50 spins. The base bet size 13 can be configured by entering an amount in a bet window 14 e.g. each bet is an amount of 5€.

Although not shown, the interface to create a game as shown in FIG. 2 can provide an interface, such as a drop-down menu, for selecting the number of players required to play the game. Further, the player can configure an expiry time, such that the game is only available for a selected period of time before it is removed from the selection in FIG. 1.

A summary 15 is presented that highlights the parameters of the games. Overall, this interface enables a player to select the set of actions to be performed and alter the variables within that set of actions. After configuring the game a user can select a create button 16 to load the game to the table of FIG. 1, and await another player to select a join button in FIG. 1, wherein a second player/user can accept one of the existing games that have been created, or create their own.

Referring back to FIG. 1, when the last player required to fulfil the conditions of a game clicks the join button 8 the game can begin. Other conditions may have to be met, such as having enough credit on account, or the game still being active—but the main condition is that at least one player has created a game and the required number of players have joined. The ‘Sweet Bonanza’ game required two players and was initiated when the second player clicked the join button 8 which changed the ‘join’ button to ‘watch the game’ 8. The ‘Chaos Crem’ game is waiting for one more player to click the join button 8 before starting. Any number of players can be required for a game e.g. if the number of players 6 column indicated 99/100, then the game will start when the 100^{th} player clicks the respective join button.

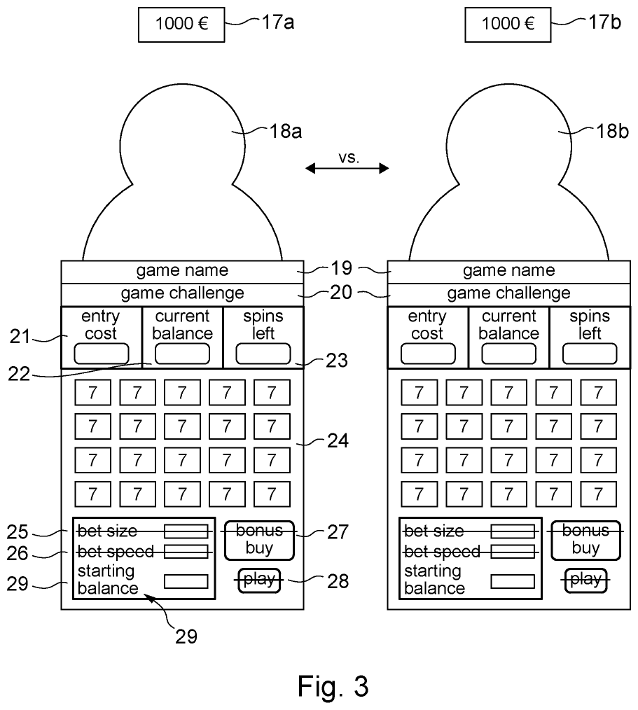

In the present example two players compete, and upon the last player joining the game each player is presented with a view of their game and a view of each of the other players' games, as shown in FIG. 3. Player 1 18a has a balance 17a of 1000€, while player 2 18b has a balance 17b of 1000€. The players' balance has already been deducted to pay for entry to the game and will not change until the game is complete. Each player's interface shows the game name 19, the game challenge 20, the entry cost 21, current balance 22 and number of spins 23 remaining. The game challenge indicates the type of game activity, such as whether the challenge includes a bonus buy, or how many spins are made.

The game-play interface of FIG. 3 includes a window 24 for displaying game-play, which is a consequence of the set of actions configured by the game creator and accepted by the other players who joined the created game. The window can include a slots-style image indicating the changing positions of the figures prior to a conclusive outcome or a spin in which the outcome of that spin can be presented. In alternative applications, the set of actions can represent characters or avatars that battle or compete to determine an outcome. Each game can have its own interface or style within the window 24 and/or the arrangement of the information presented in FIG. 3 can be varied.

It is to be noted that upon the last player joining a game a number of parameters of game-play are locked, as indicated by the buttons that would normally be selectable during a single-player game being deactivated for the user, as indicated by the ‘strikethrough’ buttons as shown—namely the bet size button 25, bet speed button 26, bonus buy button 27 and play button 28. The starting balance 29 is also fixed and indicated. Buttons are deactivated because the functions that these buttons would normally perform are disabled and become the functions and actions that they perform when selected become automatically handled as a set of actions that are performed by an emulator.

As the games are played by the emulator each user can see the consequences of the set of actions i.e. game-play, being performed in the change of the contents of the window 24 e.g. the scrolling wheels of the slots, and the outcome of each game upon the current balance 22.

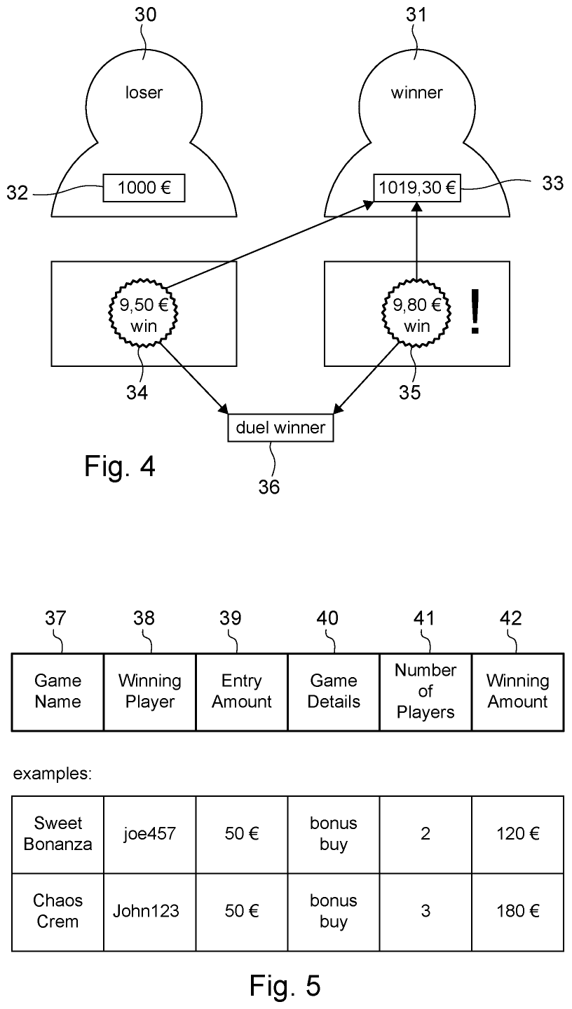

After the set of actions are complete, and game-play is concluded, the emulator determines the scores, such as the winnings, of each of the participating players. In the example of FIG. 4 two players competed resulting in a loser 30 and winner 31, and their new balances 32, 33 are shown respectively as 1000€ and 1019.30€. The balance of the loser 30 remains the same while the balance of the winner increases their balance by 19.30€, which is based on the individual winnings 34, 35 of 9.50€ an 9.80€- and the total winnings of each player are summed and allocated to the overall winner based on the determination of the duel winner 36. In other words the emulator determines and compares the outcome of each of the emulated set of actions before updating each of the users/players by reporting the results and updating the status of the overall winner.

A history of games played can be recorded, as shown in FIG. 5, in which the game name 37 is stored together with the winning player 38, entry amount 39, game details 40, number of players and the winning amount 42. From the history the previous set of actions can be analysed and statistics or patterns determined therefrom. The history can be used to monitor for errors and/or cheating.

### Emulator/Bot

A set of actions supporting game-play or the like can be performed independently for each player. The set of actions can be performed by an emulator on behalf of the player. The set of actions can be performed by an emulator that can perform a plurality of sets of actions, thus providing emulation for a plurality of players. The emulation for a plurality of players can be performed simultaneously.

A sub-set of an emulator's function can, therefore, implement a set of actions for a particular player for a particular game. The sub-set can function like a bot. The bot can be configured to implement a specific set of actions on demand for any user or player that issues a request to do so. In the context of game-play, and in relation to the example herein, an emulator can be on standby to play a game on behalf of a user, and can do so by implementing a bot for the game e.g. a sub-set of the emulator's function. Because the emulator can implement a plurality of sets of actions the emulator can be said to implement a plurality of bots. Alternatively, a plurality of emulators can be configured and each emulator provides the function of an individual bot.

The emulator can implement a bot for each player for each game to be played. The emulator can synchronise the bots that are participating in the same game, and in this way game-play is synchronised with particular actions within the set of actions being performed at substantially the same time.

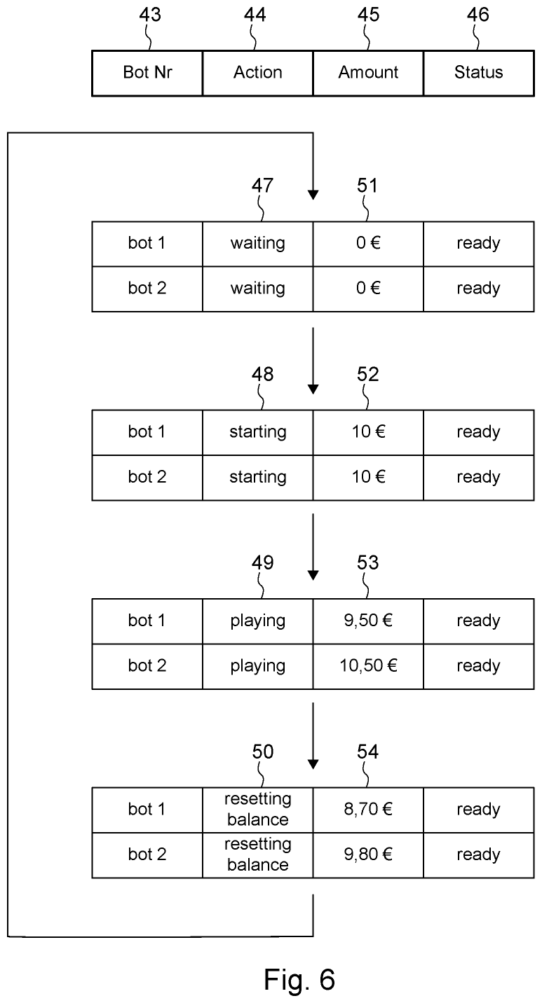

The set of actions can include stages, and in the gaming example herein FIG. 6 illustrates, by way of example, game-play actions and/or stages that an emulator performs when implementing two bots representing two competing players. As shown in the diagram of FIG. 6 the emulator monitors: a bot number 43, because the emulator can implement a number of bot functions within a server's capacity e.g. between 100 and 1000 bots; an action 44, which indicates the present state of the bot and improves the emulators ability to synchronise the set of actions representing game-play; an amount 45, which is the stake or resource being played for, as agreed by the players; and the status 46, which indicates whether the bot is, for example, ‘ready’ for play, operating and available for supporting a new game.

The monitoring of the bots can be used to detect problems associated with executing a set of actions, which can include latency or connection issues or glitches between different parts of the system e.g. between the user and the server supporting the emulator and/or between the emulator and the server implanting a set of actions to support game-play.

In the example of FIG. 6, in which two players trigger an emulator to compete by playing a game on their behalf, the bots are configured to cycle through actions 44 including: waiting 47; starting; 48; playing 49; and resetting the balance 50. While the bots are waiting 47 to start their balance amount 45 is 0€ 51. Upon the second of two players joining the game, the bots are allocated to the respective players and the players entry cost of 10€ 52 is added to the balance and the action 44 status is set to ‘starting’, as the emulator prepares each bot to initiate game-play. The entry cost has been set by one of the players and accepted by the other players. The entry cost of 10€ 52 is provided by way of example only for game-play at 1 € per spin and the game has been configured to spin 10 times. Preparation can include at least one of configuring the connection with a game provider and setting the parameters of the game-play, such as the bet amount, the speed of play and number of actions to be performed. Each bot plays by performing the set of actions and updates the balance amount for each bot to 9.50€ and 10.50€, respectively—the balance amount at this stage is provided by way of example only because there are thousands of possible outcomes during the performance of the set of actions. Each bot plays by performing the set of actions and the output of the actions determines an overall outcome after the game-play has completed, after which the emulator determines which player has the highest winnings or score. In this example, prior to resetting the balance, bot 1 has scored 8.70€ and bot 2 has scored 9.80€.

In this example the player represented by bot 2 would acquire the winnings of the player represented by bot 1 i.e. 18.50€. It is to be noted that different game-play rules can be configured and the invention is not limited by the examples herein.

After determining the outcome of the set of actions between the bots e.g. which player/bot won the game, the balance is reset and the bots return to a ‘waiting’ state in preparation for the next emulation of the set of actions.

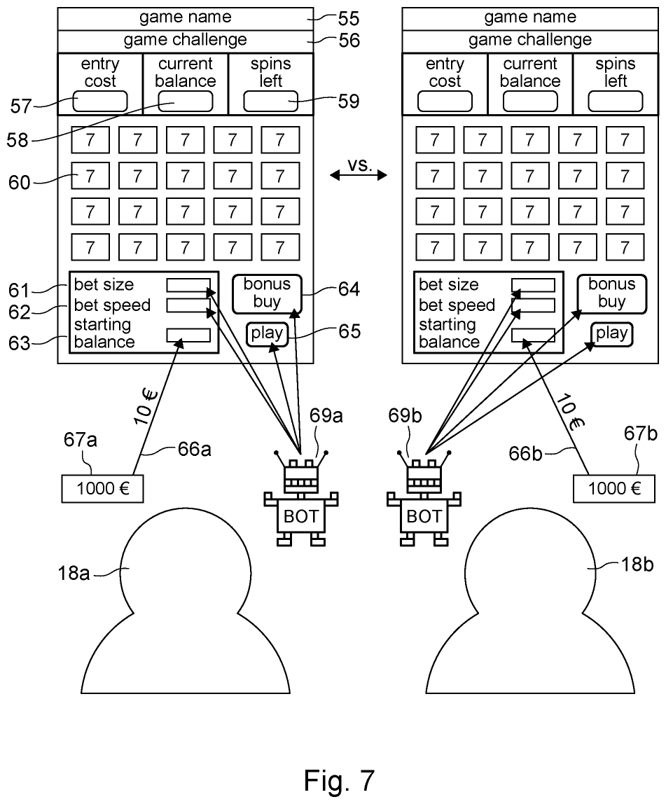

FIG. 7 illustrates the interface that two competing users 18a, 18b would experience during game-play. In the user interface each player can see their game-play window and their competitor's window. Each window presents details of the game that one of the players configured and the other joined. The window includes details such as the game name 55, game challenge 56 description, entry cost 57, current balance 58, spins left 59, the game-play window 60, bet size 61, bet speed 62, starting balance 63, bonus buy 64 button and play 65 button. The game challenge indicates the type of game activity, such as whether the challenge includes a bonus buy, or how many spins are made.

Each user deposits funds 66a, 66b of 10€ to the starting balance 63, which results in the current balance 58, 67a, 67b becoming 1000€. The emulator, by way of the bots 69a, 69b functionality, has control of the bet size 61, the bet speed 62 and the bonus buy 64 and play buttons 65, and the authority to spend the starting balance as part of the game-play. As described above, the buttons that are controlled by a bot are deactivated in the users' interface such that the emulator controls play and the users are unable to abandon the game or change the game configuration that was agreed upon.

During game-play the slot reels can be watched during game-play in the game-play windows 60, said slot reels activated by the bots 69a, 69b, which have set the best size according to the instructions provided by the users during the game configuration. If a game challenge 56 includes a ‘bonus buy’ 64 the bot can perform an action to replicate pressing said button.

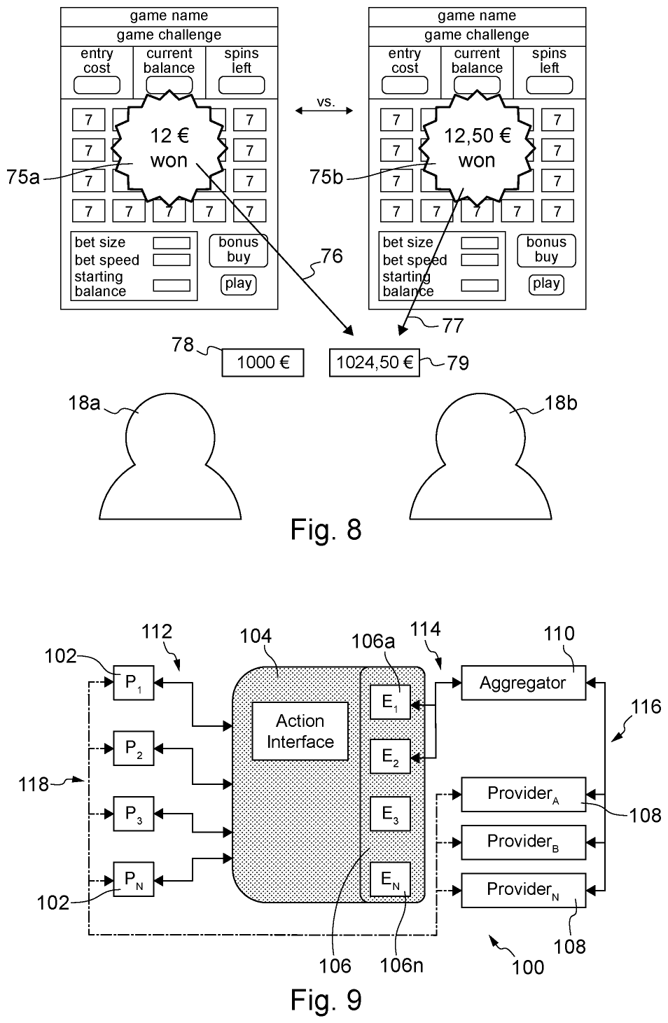

By way of example, the results of the game in FIG. 7 are shown in FIG. 8, in which first 18a and second 18b players are presented with the result 75a, 75b of the game-play for each player, namely that the result for the first player was a 12€ win, while the second player won 12.50€. The player who achieved the highest result with the greatest winnings acquires the winnings of the other players. In this example, thus in this instance the first user's balance 78 is kept at 1000€, while the second user's balance 79 is increased to 1024.50€.

### System Architecture—Single-Player

In a conventional single-player game, such as an on-line slots game-playable via an on-line casino's website a user would open a browser and initiate a game via the casino website. The on-line casino would open a gaming session and send a game request to a game provider server either directly or via an aggregator that provides multi-point access to many games and their associated providers' servers.

In response to a game request the game provider's server sends a URL to the user casino either directly or via the aggregator, which is then loaded in the client's browser and the game interface appears in a playing window. The user then precedes to operate the game interface to configure the game before starting the game, which in the example of an online casino involves initiating a ‘bet’ or ‘play’ by clicking or pressing on the required on-screen button. Via the URL, clicking ‘play’ instructs the game provider server to perform an action, such as spin the reels of a slot machine. The game provider's server then communicates with the casino either directly or via the aggregator that play was initiated, provides details of the game configuration and the outcome e.g. win or lose, and the casino website updates the profile and/or session of the user by updating the browser.

### System Architecture—Multi-Player

To support a multi-player game, as per the example herein, a gaming system 100 is provided as shown in FIG. 9. The gaming system has individual elements that can be remotely located from each other. The elements include: user devices 102, labelled from P₁ to P_{N}, which can be any human operable computing device, such as a desktop computer, tablet or phone; a host server 104, providing an interface for the user devices 102, and for hosting access to a resource e.g. a gaming website, such as an online casino providing or providing access to games, such as slots; an emulator 106 associated with or part of the host server 104, wherein said emulator can be configured to provide individual sub-emulators 106a . . . 106n, labelled E₁ to E_{N}, for providing emulation functionality to the respective player devices P₁ to P_{N}; at least one provider server 108 for providing a resource and/or executing instructions e.g. providing an interoperable game that a player device 102 can configure and/or operate, such as a slots game for an on-line casino provided by the host server 104; and an aggregator 110, providing an intermediate connection to access two or more provider servers 108, said aggregator configured to provide a single point of access to multiple provider servers.

Each user device 102 is connectable to the host server 104 via a user connection 112. The or each emulator 106 or sub-emulator 106a is connectable via an emulator connection 114 to the aggregator 110. The aggregator, in turn, is connectable to a provider server 108 via an aggregator connection 116. It is to be noted that the aggregator 110 and the aggregator connection 116 are optional, and that the or each emulator 106 or sub-emulator 106a can be connectable to a provider server 108 without an aggregator. A provider connection 118 enables the user device 102 to be connected to the provider server 108. Each emulator can also be configured with their own connection to the aggregator or provider server.

The system 100 and elements thereof, alone or in combination, enable the configuration of actions upon a player device 102 to be performed on a provider server 108, and these actions are exemplified by game-play, and in particular the configuration of a set of actions and the setting of a condition to be met before these actions e.g. game-play, commence. As described above, each player is a ‘user’ of the system. Further, the set of actions performed upon a provider server are initiated by an emulator 106 of the host server 104 on behalf of each of the plurality of users 102, said set of actions defined by at least one user, wherein the emulator determines and compares the outcome of each of the emulated set of actions and communicates the outcome to each of the plurality of users.

The emulator 106 functions to enable the host server 104 to operably engage with the provider server 108 to perform the set of actions. The set of actions are configured upon the user device 102, communicated to the host server and the emulator performs the set of actions on behalf of the user. In the present example, the emulator performs a game on behalf of a user. The game can include several cycles of the same actions e.g. repeating the spins of the wheels for each game played.

In use, two or more players that have accessed the on-line casino upon the host server 104, via their respective user connections 112, configure the set of actions required for a game. When the conditions for a game to commence have been met, the subsequent actions and determination of the outcome is entrusted to the host server 104 and the emulator 106. The emulator 106 creates a game session for each of the plurality of users' devices 102 by sending a request to the provider server 104, which configures at least one endpoint, provides a URL for at least one of: a view-only session, in which any user device 102 accessing the host server 104 can click a button 8 to watch the game, and in this session no modification or other interaction with the game is possible; the authority to configure and/or edit a user's game session, wherein parameters associated with the set of actions to be performed to carry out the game are configured, which for a slots game can include adjusting the bet size, selecting the number of spins and adjusting the speed at which bets are actioned; an endpoint to initiate game-play e.g. make a bet on behalf of the user device 102; and an endpoint to select an option in the game e.g. make a bonus buy, on behalf of the user device 102.

The host server 104 can also require endpoints on the aggregator, when used, to create a game session and/or retrieve all existing slots games from the aggregator 110. The host server can provide endpoints to receive needed data from the aggregator, such as endpoints to retrieve a client's balance and/or an endpoint to retrieve a call-back (message/response) after an emulator has performed an action e.g. made a bet in slot, and receive the result of that action/bet.

Users, via their devices 102, no longer directly engage with a server provider for implementing the set of actions that represent game-play, and the emulator 106 performs this function on behalf of all participating users—either as a single entity, or with sub-emulators 106a representing individual users. In other words the emulator provides instructions to the provider server 108 in a way that simulates operations performed by the user devices 102. The simulation can provide instructions that simulate mouse-and-click operations and/or send requests that represent the actions to be performed before, during and after game-play.

Not only can the emulator be configured to request and engage with such endpoints, but a provider server can be configured to liaise with an emulator. Therefore, the provider server 108 is configured to provide a game session in response to a request from an emulator, said game session including establishing at least one endpoint and sending a URL for at least one of: a view-only session, in which any user device 102 accessing the session can watch the game, but be prevented from modifying or interacting with the game; providing the emulator with the authority to configure and/or edit a user's game session, wherein parameters associated with the set of actions to be performed to carry out the game are configured e.g. for a slots game this can include adjusting the bet size, selecting the number of spins and adjusting the speed at which bets are actioned; an endpoint to initiate game-play e.g. make a bet on behalf of the user device 102; and an endpoint enabling an emulator to select an option in the game e.g. make a bonus buy, on behalf of the user device 102. Further, the emulator 106 and the provider server 108 can be configured to send and receive requests, respectively, in the format of action-specific instructions.

Overall, the emulator 106 and the corresponding interfaces of the provider server 108, can be said to provide dedicated and secure channels 114, 116, 118 between the host server 104 and the provider server, and ultimately the users 102. Not only does the function of the emulator inhibit cheating by the competing users but the secure channels enable the emulator to synchronise game-play and/or each stage of the game-play to improve security and/or minimise latency during game-play.

### Operations—Multi-Player

In use, the host server 104 provides access to multi-player games. Once a configured game has been accepted by the required number of players the conditions are satisfied and the host server treats acceptance by committed players e.g. the last required player click ‘join’ 8 as confirmation that all players have complied and agree to play. The host server then configures the emulator 106 to perform a set of actions representing the game upon a provider server 108 and determine the outcome of the game. The host server can then update each user.

Similarly, a provider server 108 is configured to receive and execute instructions determined by a plurality of users via an emulator residing in a host server. The instructions represent a set of actions configured by a remote user and issued by the emulator. The provider server configures a plurality of endpoints configured to engage with an emulator of the host server, said endpoints configured to receive at least one of an input from the emulator simulating the operation of a user selecting an action, and request from the emulator to perform an action. The provider server has at least one processor arranged to execute the set of actions received from the emulator and/or update at least one of the plurality of user-interfaces and the emulator with an outcome of the actions via the plurality of endpoints.

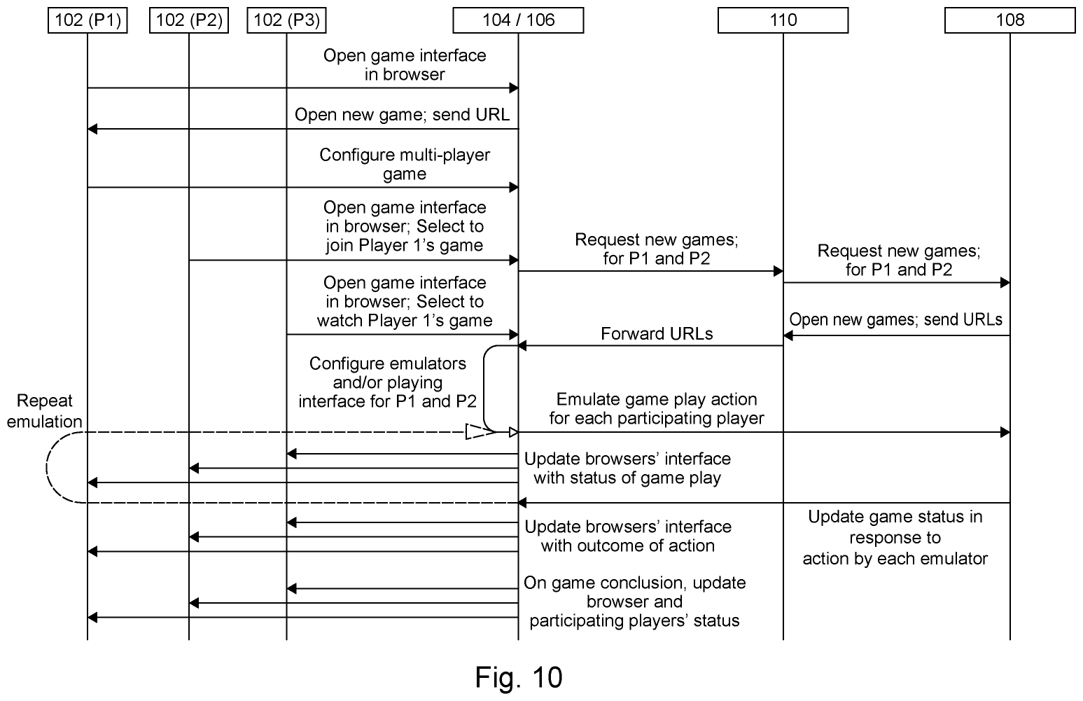

FIG. 10 illustrate, at least in part, the steps that occur within the system in which a set of actions are configured upon a user device 102 by a user, controlled by an emulator 106 on behalf of each of the plurality of users, and performed upon a provider server 108. The emulator determines and compares the outcome of each of the emulated set of actions and communicates the outcome to each of the plurality of users. Once again, by way of non-limiting example, the invention is explained using game-play and, in particular, with two players competing and a third user watching the game.

The process of establishing and playing a game begins with a user, a first player 1 (P1), opening a browser or similar interface, such as an app or on their device 102 and sending a request to the host server 104, which hosts an on-line casino. In response the host server sends a URL to the user (P1) device 102 to provide a gaming interface, as per FIG. 1, in which three options are presented—namely to create a game, join a game of watch a game.

Via the host server 104 and the user device 102 (P1) the first player selects to create a game and configures the game using the interface presented in FIG. 2. When the game and the corresponding set of actions for performing the game is configured it is added to the list shown in FIG. 1 with a ‘join’ button shown until the conditions for playing the game have been met i.e. the required number of players have joined the game. In the present example, the game has been configured for 2 players, for 20 spins of the reels of the slots game with a wager of 5€ per spin.

Via the host server 104 another user device 102 (P2) and second player opens a browser or similar interface, such as an app or on their device 102 and sends a request to the host server 104. In response the host server sends a URL to the user device 102 of the second player (P2) to provide a gaming interface, as per FIG. 1, in which three options are presented—namely to create a game, join a game of watch a game. The second player (P2) selects to join the game created by the first player (P1). By selecting to ‘join’ 8 the second player accepts the parameters configured by the first layer and satisfies the condition that the required number of players have committed to play.

The invention resides in the system, or elements thereof, supporting the emulation of game-play on behalf of the users committed to play against each other. It is clear in light of the teaching herein that the number of players is limited only by the capacity of the system, such that many more than two players can compete e.g. up to 20, or up to 50 or even 100 or more. Further, while the games are proposed by a first player and accepted by the remaining players in the present example the host server 104 can provide a communication mechanism enabling players to barter and/or agree upon a set of game parameters before initiating and collectively agreeing to ‘join’ a game and trigger the start of game-play. Moreover, each of the plurality of players can configure their own game parameters such that two or more different sets of actions representing game-play compete i.e. game actions are not the same for each player competing in a game i.e. a first player selects 20 spins of the reels in a slots game with a wager of 5€ per spin, while a second player selects 15 spins of the reels in a slots game with a wager of 7€ per spin, and configure the game such that the player with the highest score acquires all of the winnings.

Upon the second player (P2) selecting to ‘join’ the first player's game, the host server 104 allocates the emulator 106 to perform the set of actions required to implement game-play for the first and second player (P1, P2). A single emulator can process multiple games on behalf of multiple players simultaneously. Additionally or alternatively, the processing function of the emulator can be subdivided and configure one or more sub-emulators 106a to simulate game-play (i) collectively for all of the players participating in the game configured by the first player, or (ii) individually, for each player. For simplicity the example herein will refer to the emulator generically.

After the second player (P2) selects to ‘join’ the emulator 106 sends a request for a new game to the provider server 108, which can be via an aggregator. The provider server responds by opening the required games and sending a URL to the emulator.

Via the host server 104 a third user device 102 (P3) opens a browser or similar interface, such as an app or on their device 102 and sends a request to the host server 104. In response the host server sends a URL to the user device 102 of the third user (P2) to provide a gaming interface, as per FIG. 1, in which three options are presented—namely to create a game, join a game of watch a game—and the third player (P3) elects to watch the game between the first (P1) and second (P2) player when it starts.

The URLs sent by the provider server 108 include (i) a view-only URL, that is relayed on to each of the participating user's devices 102 (P1, P2 and P3) enabling each user's device to display game-play, and (ii) a ‘game-play’ URL enabling the emulator 106 to communicate with the provider server and play the games on behalf of the user devices 102. Each user then sees their playing window, and the playing window of the other player—as per FIG. 3.

Using the game-play URL the emulator 106 sends requests to the provider server 108 that emulate the set of actions representing game-play for each player, and in response the provider server updates the game status, at the host server 104 that, in turn, relays the updates to the players and viewer. The emulator requests include at least one of signalling that the emulator, on behalf of a player, is: waiting to play; confirming a starting amount; activating play e.g. spinning the reels of the slots; repeating activating play the set number of times; updating the balance or score of each player; determining which one of the competing players obtained the highest score and bots was the winner; allocating the winnings to the winner; and updating the profile of each of the user devices 102 of the competing players.

The example herein is based on three human participants—two competing players, with a third player observing the game. At least one of the competing players can be a non-player entity and simulated by the host server 104.

### Operations—Third-Party Observers (Non-Participating Players)

A set of actions representing game-play can be performed by an emulator 106 on behalf of the player, and the interaction between the emulator 106 and/or host server with the server provider 108 can operate in at least one of two approaches, as follows:
1) The emulator 106 makes a bet on behalf of the user or plurality of users. The emulator can also request that third parties can watch the game without playing. A provider server can accommodate these requests and update, via a provider connection 118, all user front-ends who are watching the game, based on the request from the emulator. It is envisaged, however, that accommodating this request can require a provider server to modify their operations to accommodate and support these requests. However, some provider servers 108 are configured to communicate, at least in part, progress on the outcome of the emulation to the interface and/or each user on an individual player basis. This means that live game play and/or interaction is restricted to each specific player and/or their emulator performing a set of actions on the player's behalf. Such individual configuration can restrict access to the endpoints thus prohibiting other players and third party observers from watching game play simultaneously. Opening access to the endpoints is possible with a reconfiguration of the provider server, but such reconfiguration can involve at least one of updating the program to meet regulatory requirements, an increased risk of program instability following reprogramming.
2) The emulator 106 makes a bet on behalf of the user or plurality of users. The emulator can also request that third parties can watch the game without playing. Rather than a provider server 108 accommodating these requests and updating each user via a provider connection 118, the provider server communicates only with the emulator 106. Therefore, a provider server does not have to modify to modify their operations to accommodate and support requests from an emulator to provide multiple user access to game-play. After an emulator 106 has made a bet (requested execution of a set of actions) on behalf of the user it receives the results and processes them via the action/user interface of the host server 104. The host server collates the response for the provider server 108 for each set of actions representing game play for each competing player such that competing players and third party observers can observe game play.

In one example of implementing the second approach mentioned above, after a first player 1 (P1) establishes a game that is accepted and joined by a second player (P2) the emulators 106 are allocated to respective players to perform the set of actions required to implement game-play for the first and second player (P1, P2). The provider server 108 can then respond by opening the required games and sending a URL to the emulator, as described above. The URLs sent by the provider server 108 can include a ‘game-play’ URL enabling the emulator 106 to communicate with the provider server 108 and play the games on behalf of each of the user devices 102. The emulator(s) 106 connected to these URLs collates the game play information such that competing users can observe their own game-play in their user-interface as well as the game-play of the other users they are competing against—as per FIG. 3. Third parties can also be permitted to observe the game play collated by the host server 104.

To inhibit synchronisation issues and allow each user perceives game-play as occurring substantially simultaneously with other game players, the provider server can perform the set of actions for game play at an accelerated speed while continuing to comply with the predetermined game configuration and/or regulatory requirements for performing said set of actions e.g. the game. The results of each game can be provided to the emulator and the user interface of the host server 104, which then takes the results for all users that are watching that game and providing a simulation and/or replay before the results are presented.

The accelerated speed can conclude game-play e.g. each individual spin or all of the spins, within a fraction of the normal time set of actions are performed and presented to a player. During normal game-play, a user might initiate a set of actions representing game play and observe the response over a period of between 1 second and 5 seconds, depending on the game being represented by a set of actions i.e. the results of a black-jack game can be actuated relatively quickly, while a game of roulette or slots takes time for the result to be known. In light of the emulator 106 communication with the provider server 108 to obtain game results before collating said results and providing a simulation and/or replay, the time between initiating a set of actions and obtaining results can be accelerated, with results being provided within a period of up to 10 ms, and preferably within a period of up to 1 ms.

Therefore, rather than relay the progress and outcome of the set of actions representing game play as the game is played, the host server 104 records and replay the game-play in real time. The replay of each game can be gathered by the host server and collectively presented to each player or observer. The outcome of the game-play is unaffected by the recording and replaying of the game because the delivery of the results are merely postponed to coincide, substantially, with the normal amount of time required to perform a set of actions. Any minor delay, such as between 1 ms and 10 ms, is imperceptible to users.

Not only does this second approach avoid the need for a provider server to make modifications to accommodate multiple users, but the collation of the game results and simulation and/or replay by the host server 104 can provide secure and efficient communication that inhibits any tampering with game-play.

### Element Architecture

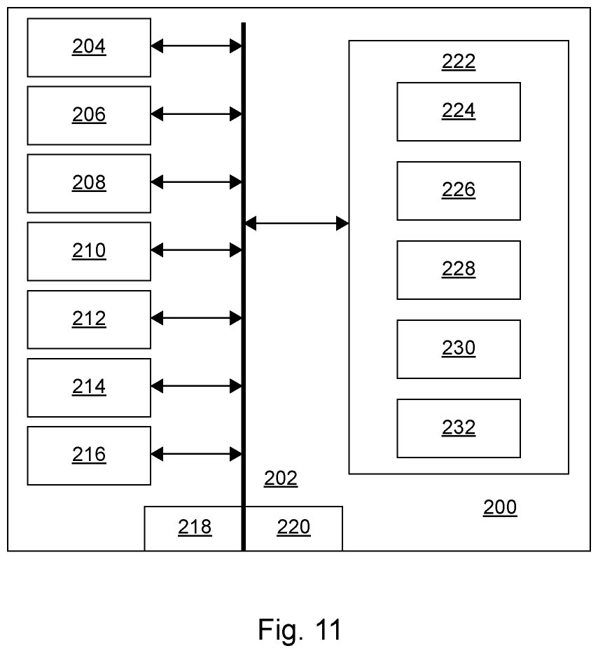

The elements of the system 100, namely the user device 102, host server 104, provider server 108 and aggregator 100 are configured to include a computer 200. FIG. 11 is a schematic of the computer 200 of the system 100 configured to control the or each of the elements. The computer 200 can be scalable in size to accommodate additional components adopted on to the element. The computer 200 includes a bus 202, at least one processor 204, at least one communication port 206, a main memory 208 and/or a removable storage media 210, a read only memory 212 and a random access memory 214. The components of computer 200 can be configured across two or more devices, or the components can reside in a single computer 200. The computer can also include a battery 216. The port 206 can be complimented by input means 218 and output connection 220. The processor 204 can be any such device such as, but not limited to, an Intel®, AMD® or ARM processor. The processor may be specifically dedicated to the device. The port 206 can be a wired connection, such as an RS-232 connection, or a Bluetooth connection or any such wireless connection. The port can be configured to communicate on a network such a Local Area Network (LAN), Wide Area Network (WAN), or any network to which the computer 200 connects. The read only memory 212 can store instructions for the processor 204.

The bus 202 communicably couples the processor 204 with the other memory 210, 212, 214, 208 and port 206, as well as the input and output connections 218, 220. The bus can be a PCI/PCI-X or SCSI based system bus depending on the storage devices used, for example. Removable memory 210 can be any kind of external hard-drives, floppy drives, flash drives, for example. The device and components therein are provided by way of example and does not limit the scope of the invention. The processor 204 can implement the methods and perform any of the calculations described herein. The processor 204 can be configured to retrieve and/or receive information from a remote server or other device.

The computer 200 of the elements can also include an application program interface (API) 222 for processing instructions received another of the elements e.g. via an app on a mobile device. The computer can include a games store 224 holding DLLs for each of the games the system supports. A parameter store 226 and condition store 228 can hold a detailed record of past and current game-play. A game memory 230 can store details of the active games as well as the history of games played. A security module 232 can provide an additional level of security to the communication and security of the data stored and communicated from the computer 200.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teaching of the present disclosure is/are used. Those skilled in the art will recognize or be able to ascertain using no more than routine experimentation, many equivalents to the specific embodiments of the disclosure described herein.

It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The invention also consists in any individual features described or implicit herein or shown or implicit in the drawings or any combination of any such features or any generalisation of any such features or combination. Thus, the present disclosure provides technical solutions to a variety of technical problems, including, but not limited to, those mentioned above.

It should be noted that the above-mentioned examples illustrate rather than limit the disclosure, and that those skilled in the art will be capable of designing many alternative examples without departing from the scope of the disclosure as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. Throughout this specification the word “comprise”, or variations such as “includes”, “comprises” or “comprising”, will be understood to imply the inclusion of a stated element, integer or step, or group of elements, integers or steps, but not the exclusion of any other element, integer or step, or group of elements, integers or steps. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage. The term “user” may refer herein to a human or a processor-based resource.

1. A method of operating a host server including configuring an interface for receiving from a plurality of users and operating a provider server, the method comprising:
providing an interface for communicating with a plurality of user-interfaces;
receiving instructions from the user-interfaces that determine a set of actions and to be performed on a provider server and a condition;
determining whether the set of actions and the condition are accepted by the plurality of users, including a first user and a second user; and
configuring an emulator in response to the condition being met, said emulator configured to:
establish communication with a provider server upon determining that the set of actions and the condition are accepted;
emulating the set of actions for each of the plurality of users by initiating automatic execution of the set of actions upon the provider server;
updating the plurality of user-interfaces with an outcome of the actions.

2. The method of claim 1, wherein emulation for the plurality of users occurs in parallel.

3. The method of claim 1, wherein in response to said condition being met the set of actions is locked and inhibited from reconfiguration by any of the plurality of users.

4. The method of claim 1, wherein the server communicates, at least in part, progress on the outcome of the emulation to the interface.

5. The method of claim 4, wherein the progress is streamed to the plurality of users.

6. The method of claim 1, wherein a passive user requests via the interface to observe the progress on the outcome of the emulation to the interface, without participating in the emulation of actions, and the server communicates progress on the outcome of the emulation to the interface.

7. The method of claim 1, wherein the emulation of the set of actions for each of the first user and the second user and/or progress on the outcome of the emulation to the interface is repeated.

8. The method of claim 1, wherein the emulation of the set of actions includes a separate emulator and/or emulation process for each of the first user and the second user.

9. The method of claim 1, wherein the outcome of the set of actions emulated for the first user is compared to the outcome of the set of actions emulated for the second user.

10. The method of claim 1, wherein the outcome of a set of actions determines a score.

11. The method of claim 10, wherein the first user and the second user allocate a resource to their respective set of actions, and the outcome of the emulation modifies the respective resource, which determines the respective score, wherein the scores of the first user and the second user are compared.

12. The method of claim 11, wherein the resource accumulated when all emulations are complete are allocated to the user with the greatest score.

13. The method of claim 1, wherein the plurality of users operate the interface via a user-interface via which the users engage with a host server to define the set of actions and/or meet the conditions,
wherein upon meeting the condition the host server establishes a connection with the provider server via an endpoint and/or emulates the set of actions for each of the plurality of users.

14-16. (canceled)

17. A method of configuring a provider server configured to execute instructions determined by a plurality of users via an emulator, the method comprising:
configuring an interface to receive instructions that determine a set of actions, said set of actions (i) determined by a plurality of remote users and/or (ii) determined by requests received from a host server;
providing a plurality of endpoints configured to engage with an emulator of a host server, said endpoints configured to receive at least one of
an input from the emulator simulating the operation of a user selecting an action, and
a request from the emulator to perform an action,
wherein said action is part of a set of actions determined from a plurality of different users; and
configuring a processor to execute the set of actions received from the emulator and update at least one of the plurality of user-interfaces and the emulator with an outcome of the actions via the plurality of endpoints.

18. A method of configuring a system for automatically performing actions on a provider server providing a platform for executing actions, said remote provider said actions determined by a plurality of users, said method comprising:
configuring via an interface a set of actions and a condition, and accepting the set of actions and a condition, wherein the set of actions and the condition are determined and accepted by the plurality of users, including a first user and a second user;
in response to said condition being met, initiating automatic execution of the set of actions upon the provider server, wherein the execution of the set of actions is emulated;
emulating the set of actions for each of the plurality of users.

19. The method of claim 1, wherein the provider server is one of a plurality of provider servers selectably accessed via an aggregator, said aggregator functioning for at least part of the method, as an intermediary gateway between at least one of the user, a host server and a provider server.

20. A host server configured to provide an interface to a plurality of users and operate a provider server, the host server comprising:
an interface configured to:
communicate with a plurality of user-interfaces;
receive instructions that determine a set of actions and a condition; and
determine whether the set of actions and the condition are accepted by the plurality of users, including a first user and a second user; and
an emulator, configured to:
establish communication with a provider server upon determining that the set of actions and the condition are accepted; and
initiate automatic execution of the set of actions upon the remote server, and update the plurality of user-interfaces with an outcome of the actions.

21-25. (canceled)
